(19) United States
(12) Patent Application Publication
(10) Pub. No.: US 2023/0239358 A1
(43) Pub. Date: Jul. 27, 2023

(54) METHOD FOR FOWARDING DATA, DEVICE, STORAGE MEDIUM AND DATA TRANSMISSION SYSTEM

(71) Applicant: Beijing Baidu Netcom Science Technology Co., Ltd, Beijing (CN)

(72) Inventors: Fenghui Zhang, Beijing (CN); Yun Gu, Beijing (CN); Yishuang Geng, Beijing (CN); Zhuoran Xu, Beijing (CN)

(73) Assignee: Beijing Baidu Netcom Science Technology Co, Ltd., Beijing (CN)

(21) Appl. No.: 17/896,216

(22) Filed: Aug. 26, 2022

(30) Foreign Application Priority Data
Jan. 27, 2022 (CN) 202210097991.4

(51) Int. Cl. H04L 67/14

(52) U.S. Cl. CPC H04L 67/14

(57) ABSTRACT

A method for forwarding data, a load balancing device, a computer readable storage medium, and a data transmission system. An implementation of the method includes: obtaining a data packet sent by a client, and extracting an actual session parameter from the data packet; in response to the actual session parameter being an unrecorded session parameter, reading information from a preset field address constituting a packet header of the data packet; wherein a preset field corresponding to the preset field address is configured to record information used to determine a target server parameter; in response to determining that the information read from the preset field address is not empty, determining, based on target information read from the preset field address, the target server parameter as a client communication object; and forwarding the data packet to a target server corresponding to the target server parameter.

### CROSS-REFERENCE TO RELATED APPLICATIONS

This application claims priority to Chinese Patent Application No. 202210097991.4, filed with the China National Intellectual Property Administration (CNIPA) on Jan. 27, 2022, the content of which is incorporated herein by reference in its entirety.

### TECHNICAL FIELD

The present disclosure relates to the technical field of data processing, in particular to the technical field of cloud services, load balancing, and media cloud, and more particularly, to a method for forwarding data, a load balancing device, a computer readable storage medium, and a data transmission system.

### BACKGROUND

With the rapid development of communication technology and rapid popularization of smart devices, users often hold the same smart device to frequently span or switch between multiple network environments.

In a traditional data transmission method based on TCP (Transmission Control Protocol), due to its connection-oriented characteristics, when the same client switches between network environments (such as switching from a WIFI scenario in the house to a 4G or 5G data connection scenario outside the house), it may change to a different IP address due to the switching of the network environments, which thus leads to disconnection of a session with a server created based on an original IP address, and a new session with the same server is recreated based on the new IP address.

This process is reflected on a user side using the client, and may appear as requiring the user to re-authenticate.

How to avoid the authentication performed when the previous session is disconnected and the new session is created, is an urgent problem to be solved by those skilled in the art.

### SUMMARY

Embodiments of the present disclosure propose a method for forwarding data, a load balancing device, a computer readable storage medium, and a data transmission system.

In a first aspect, some embodiments of the present disclosure provide a method for forwarding data, the method includes: obtaining a data packet sent by a client, and extracting an actual session parameter from the data packet; in response to the actual session parameter being an unrecorded session parameter, reading information from a preset field address constituting a packet header of the data packet; wherein a preset field corresponding to the preset field address is configured to record information used to determine a target server parameter; in response to determining that the information read from the preset field address is not empty, determining, based on target information read from the preset field address, the target server parameter as a client communication object; and forwarding the data packet to a target server corresponding to the target server parameter.

In a second aspect, some embodiments of the present disclosure provide a load balancing device. The load balancing device includes: at least one processor; and a memory communicatively connected to the at least one processor; where the memory stores instructions that, when executed by the at least one processor, cause the at least one processor to perform the method for forwarding data according to any one of the implementations described in the first aspect.

In a third aspect, some embodiments of the present disclosure provide a non-transitory computer readable storage medium. The non-transitory computer readable storage medium stores computer instructions that, when executed by a computer, cause the computer to perform the method for forwarding data according to any one of the implementations described in the first aspect.

In a fifth aspect, some embodiments of the present disclosure provide a data transmission system. The data transmission system includes the load balancing device described in the second aspect, a client end configured to send a data packet to the load balancing device, and a server configured to receive the data packet from the load balancing device.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

After reading detailed descriptions of non-limiting, embodiments with reference to the following accompanying drawings, other features, objectives, and advantages of the present disclosure will become more apparent:

FIG. 1 is an example system architecture diagram to which embodiments of the present disclosure may be applied;

FIG. 2 is a flowchart of a method for forwarding data according to an embodiment of the present disclosure;

FIG. 3 is a flowchart of another method for forwarding data according to an embodiment of the present disclosure;

FIG. 4 is a flowchart of a method for processing a timeout session parameter based on a dynamic keep-alive duration according to an embodiment of the present disclosure;

FIG. 5 is a structural block diagram of an apparatus for forwarding data according to an embodiment of the present disclosure; and

FIG. 6 is a schematic structural diagram of an electronic device suitable for performing the method for forwarding data according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope of the present disclosure. Similarly, for clearness and conciseness, descriptions of well-known functions and structures are omitted in the following description. It should be noted that embodiments of the present disclosure and features of the embodiments may be combined with each other on a non-conflict basis.

In the technical solution of the present disclosure, the collection, storage, use, processing, transmission, provision and disclosure of the user personal information involved are all in compliance with relevant laws and regulations, and do not violate public order and good customs.

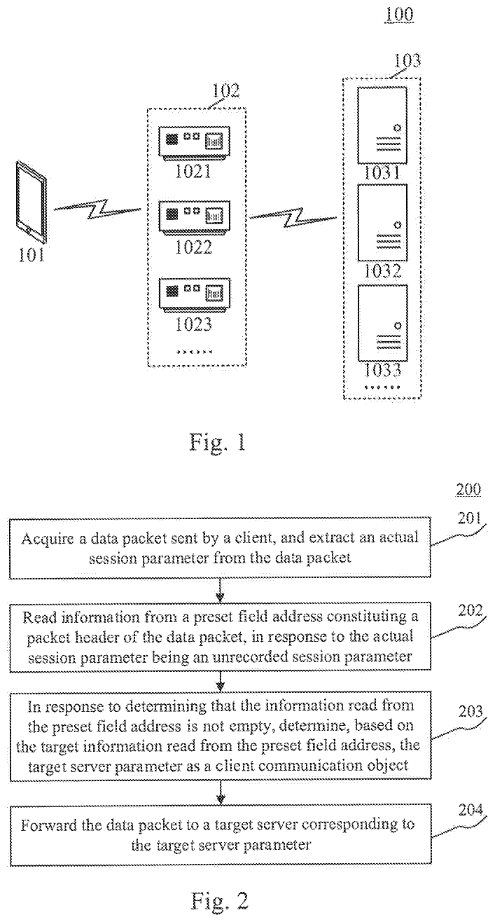

FIG. 1 shows an example system architecture a data transmission system 100, to which embodiments of a method and apparatus for forwarding data, a load balancing device, a computer readable storage medium, and a computer program product of the present disclosure may be applied.

As shown in FIG. 1, the data transmission system 100 may include a client 101, a load balancing cluster 102, and a server cluster 103. The load balancing cluster 102 includes multiple load balancing devices, such as a first load balancing device 1021, a second load balancing device 1022, and a third load balancing device 1023; the server cluster 103 includes multiple servers, such as a first server 1031, a second server 1032, and a third server 1033. The client 101, the load balancing cluster 102, and the server cluster 103 usually implement data interaction through a network, and the network may include various types of connections, such as wired or wireless communication links, or optical cables.

A user may use the client 101 to send a data packet via the load balancing cluster 102, and finally perform data exchange with a target server in the server cluster 103. Applications, such as online communication applications, data packet forwarding applications, load balancing applications, may be installed on the client 101, the load balancing device and the server to achieve various purposes including the above purpose.

The client 101, the load balancing devices constituting the load balancing cluster 102, and the servers constituting the server cluster 103 may be hardware or software. When the client 101 is hardware, it may be various electronic devices, including but not limited to smart phones, tablet computers, smart wearable devices, portable computers and desktop computers, etc.; when the client 101 is software, it may be installed in the electronic devices listed above, it may be implemented as a plurality of software or software modules, or may be implemented as a single software or software module, which is not specifically limited herein. When the load balancing devices and servers are hardware, they may be implemented as multiple computing devices having strong computing capabilities; when the load balancing devices and servers are software, they may be implemented as a plurality of software or software modules, or may be implemented as a single software or software module, which is not specifically limited herein.

The load balancing devices in the load balancing device 102 may provide various services through various built-in applications. Taking a data packet forwarding application that can provide forwarding services for a data packet sent by the client 101 as an example, when the load balancing device runs the data packet forwarding application, following effects may be achieved: first, receiving the data packet sent by the client 101 via the network, and extracting an actual session parameter from the data packet; then, when confirming that the actual session parameter is an unrecorded session parameter by itself, reading information from a preset field address constituting a packet header of the data packet, where a preset field corresponding to the preset field address is configured to record information used to determine a target server parameter; next, when confirming that the information read from the preset field address is not empty, determining, based on read target information, the target server parameter as a client communication object; and finally, forwarding the data packet to a target server (that is, a server in the server cluster 103) corresponding to the target server parameter.

It should be understood that the numbers of clients, load balancing devices and servers in FIG. 1 are merely illustrative. There may be any number of clients, load balancing devices, and servers depending on the implementation needs.

With reference to FIG. 2, FIG. 2 is a flowchart of a method for forwarding data according to an embodiment of the present disclosure, where a flow 200 includes the following steps:

Step 201: obtaining a data packet sent by a client, and extracting an actual session parameter from the data packet;

A purpose of this step is to extract the actual session parameter from the received data packet sent by the client by an executing body (for example, any load balancing device in the load balancing cluster 102 as shown in FIG. 1) of the method for forwarding data.

The session parameter refers to information used to distinguish a current session from other parameters, and a session refers to a “carrier” constructed by a client for performing data interaction with a server. The session parameter may be served by a five-tuple extracted from the data packet, and the five-tuple is: (source address: source port: protocol: destination address: destination port). That is, through addresses and port numbers of the source end and the destination end in the five-tuple, the formed five-tuple can uniquely determine a session. Of course, other information that is capable of achieving a similar effect in the data packet may also be used as the actual session parameter.

The actual session parameter described in this step is obtained by adding a prefix “actual” before a universal concept “session parameter”, and the obtained “actual session parameter” refers to a session parameter in the data packet, so as to clarify the described object and facilitate understanding in subsequent references.

Step 202, reading information from a preset field address constituting a packet header of the data packet, in response to the actual session parameter being an unrecorded session parameter;

On the basis of step 201, a purpose of this step is for that, when confirming that the actual session parameter is a session parameter not recorded by the executing body itself, the executing body tries to read the information from the preset field address constituting the packet header of the data packet, in order to determine a subsequent processing manner based on the result of the information reading. In particular, information that had been recorded previously but is deleted later or is forgotten by triggering a forgetting mechanism is also unrecorded information in embodiments of the present disclosure.

It should be noted that, under normal circumstances, for each load balancing device, after the load balancing device forwards data of a session to a server for the first time, the load balancing device may record a session parameter representing the session, so that subsequently other data packets of the same session may be forwarded quickly based on the recorded historical forwarding object. If the executing body determines that the actual session parameter is a session parameter not recorded by itself, it means that the data packet is either a data packet that the client creates a connection with the server for the first time, or the client is assigned by a load balancing mechanism to a new load balancing device responsible for forwarding a data packet sent by the client in a new network environment due to switching of network environments. In the previous network environment, the client used to forward the data packet to the target server through the previous load balancing device. Of course, the new load balancing device as the current executing body has not recorded the same session parameter. Therefore, other information may be recorded in the data packet, in order to accurately identify which situation it is, and in order that in the case of not being a first data packet, the current executing body can still accurately send the data packet to the same target server.

The data packet usually includes the packet header and a main body. The main body records the information that is actually transmitted to the target server, while the packet header records relevant information (such as various identifiers, a body data volume, a parsing method) used to enable the main body to be correctly parsed by the target server. Different information is usually recorded in different fields of the packet header. Some fields are standard fields or inherent fields required by a data packet encapsulation method and/or a data transmission protocol. Some fields are preset fields that may be customized according to actual needs and user requirements. Amount of information that each field can store is positively related to a length of the field, and usually the field length may be determined by a head address of the field and an end position of the field, or may also be determined based on offsets of the head address and the end position of the preset field relative to a start address of the packet header.

In order to enable the executing body to accurately send a non-first data packet to the same target server at the situation of that the actual session parameter of the data packet is not recorded by executing body, in an embodiment of the present disclosure the preset field corresponding to the preset field address is preconfigured to: record information used to determine a target server parameter, so that the current executing body may identify a previous communication object of the same client through the information recorded in the preset field. It should be noted that there are various methods to achieve the above effect, the number of preset fields is not limited to one, and there are also various forms for recording the information used to determine a target server parameter, the information used to determine a target server parameter may even be split and stored in different preset fields. The length of the selected preset field may also be determined based on a version of the QUIC protocol actually selected.

The information used to determine the target server parameter only needs to ensure that the recorded information can uniquely identify a server. For example, a result of performing cyclic redundancy check (such as an CRC32 calculation method) on an IP address of the target server and a communication port of the target server may be used as the information, a unique server name, server code, etc. identifiable to the executing body may also be used as the information, which is not limited herein.

Step 203: in response to determining that the information read from the preset field address is not empty, determining, based on target information read from the preset field address, the target server parameter as a client communication object;

On the basis of step 202, a purpose of this step is: in response to determining that the executing body does read information containing valid content from the preset field corresponding to the preset field address, the target server parameter is determined as the client communication object based on the read target information.

Step 204: forwarding the data packet to a target server corresponding to the target server parameter.

Based on a connection migration idea provided by the QUIC protocol, in the method for forwarding data provided by this embodiment of the present disclosure, each load balancing device, when determines that the actual session parameter of a data packet is not recorded by itself, extracts field information from the preset field address constituting the packet header of the data packet, so as to determine whether connection migration is supported based on whether valid content can be extracted, and the target server parameter may be determined based on the extracted pre-written valid content in the case of connection migration is supported. Furthermore, in the case of introducing the load balancing mechanism, it can also be ensured that the data packet is accurately forwarded to the original target server. Moreover, since there is no need to additionally set up an intermediate device that records global session information and provides global search for each load balancing device, it not only reduces an implementation cost, but also improves a forwarding efficiency.

On the basis of the above embodiment, in order to better understand how to determine that the actual session parameter is an unrecorded session parameter, a query comparison or determination step may also be added before step 202, an implementation including but not limited to may be:

querying the actual session parameter in a memory space corresponding to a current central processing unit;

in response to determining that a session parameter same as the actual session parameter is not stored in the memory space, determining the actual session parameter as the unrecorded session parameter; or

in response to determining that a session parameter same as the actual session parameter is stored in the memory space, determining the actual session parameter as a recorded session parameter, and forwarding the data packet to a target server corresponding to the recorded session parameter.

In the present embodiment, the memory space corresponding to the current central processing unit is selected to record historical session parameters, so as to improve a speed of data query and data comparison by virtue of high-speed read and write characteristics of the memory space. If the session parameter same as the actual session parameter is stored in the memory space, the actual session parameter may be determined as being a recorded session parameter, and the data packet may be forwarded to the target server corresponding to the recorded session parameter, so that the data packet can be quickly and accurately forwarded to the same target server to achieve the effect of connection migration.

Further, the memory space includes an exclusive memory space corresponding only to the current central processing unit, and a shared memory space corresponding to multiple central processing units including the current central processing unit at the same time. Compared with the shared memory space, the exclusive memory space is simpler in configuration, has a faster data operation speed, and there is no need to consider problems such as conflicts and locks caused by sharing. However, in some cases where a total memory space is limited or there is no conflict, the shared memory space may also utilize the limited memory space with higher efficiency, avoiding repeated storage of different session parameters of the same session.

At the same time, the implementation of choosing the exclusive memory space also means that each CPU only needs to maintain its own recorded session parameter in its own exclusive memory space, and no additional configuration is required for maintaining the shared memory space, therefore, there is no consequent performance degradation. It is necessary to flexibly select the most suitable method according to the actual situation in specific application scenarios and considering all possible special requirements, which is not limited herein.

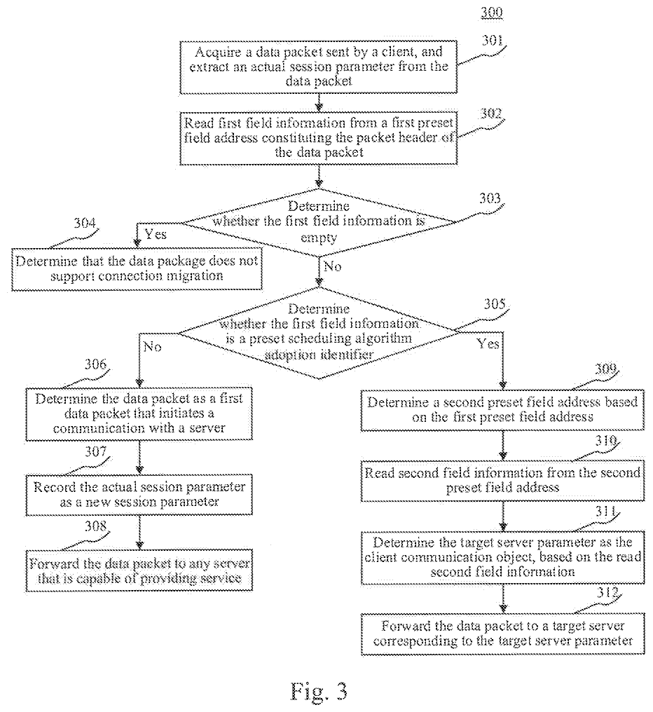

With reference to FIG. 3, FIG. 3 is a flowchart of a method for forwarding data according to another embodiment of the present disclosure, where a flow 300 includes the following steps:

Step 301 obtaining a data packet sent by a client, and extracting an actual session parameter from the data packet;

Step 302: reading first field information from a first preset field address constituting the packet header of the data packet;

The first preset field address corresponds to a first preset field, and this step is equivalent to reading the first field information from the first preset field of the packet header by the executing body.

Step 303: determining whether the first field information is empty, if yes, performing step 304, otherwise performing step 305;

A purpose of this step is to select different subsequent processing branches based on whether the read first field information is empty by the executing body.

Step 304: determining that the data package does not support connection migration;

This step is based on the judgment result of step 303 that the first field information is empty, that is, no information is recorded in the first preset field, and a purpose of this step is to determine, by the executing body, this situation as the data package does not support connection migration.

Step 305: determining whether the first field information is a preset scheduling algorithm adoption identifier;

This step is based on the judgment result of step 303 that the first field information is not empty, that is, information is recorded in the first preset field, and a purpose of this step is to further determine, by the executing body, whether the first field information is a preset scheduling algorithm adoption identifier. The scheduling algorithm adoption identifier is used to denote that the data packet adopts a preset scheduling algorithm.

From the description of the two processing branches of the judgment result of step 303 in steps 304 and 305, it can be seen that in the present embodiment, the first preset field is pre-configured as a field for recording the scheduling algorithm adoption identifier. Since the scheduling algorithm is to enable the load balancing device serving as the executing body to correctly forward the data packet to the same target server, thus based on the scheduling algorithm adoption identifier is stored in the data packet, it may be reversely determined whether the data packet is a data packet using the QUIC protocol. That is, when the QUIC protocol is not used, it means that there is no need to determine whether connection migration processing is required for the data packet.

Step 306: determining the data packet as a first data packet that initiates communication with a server;

This step is based on the judgment result of step 305 that the first field information is not the preset scheduling algorithm adoption identifier, and a purpose of this step is to determine, by the executing body, the data packet as a first data packet that initiates communication with a server.

In order to achieve this effect, it is also necessary to determine timing of writing the scheduling algorithm adoption identifier in the first preset field as a non-first data packet in communication with the server. Therefore, when the read first field information is not empty, and the first field information is not the scheduling algorithm adoption identifier, it may be considered that the data packet is determined as the first data packet that the client initiates communication with a server.

Step 307: recording the actual session parameter as a new session parameter;

Step 308: forwarding the data packet to any server that is capable of providing services;

On the basis of step 306, in steps 307 and 308, the executing body may record the actual session parameter as the new session parameter, and then choose to forward the data packet to any server that is capable of providing services for a new session corresponding to the new session parameter. Here, criteria for being recognized as capable of providing services is not limited herein, may be determined by itself in light of the actual situation.

Step 309: determining a second preset field address based on the first preset field address;

Step 310: reading second field information from the second preset field address;

Step 309 is based on the judgment result of step 305 that the first field information is the scheduling algorithm adoption identifier, and a purpose of this step is to determine, by the executing body, the second preset field address based on the first preset field address, so that in step 310, the second field information may be read from the second preset field address.

In the present embodiment, in order to ensure that the second field information is accurately read to determine the target server parameter, the second preset field address corresponding to the second preset field is set to be based on the first preset field address, so as to avoid that in sonic scenarios, the valid second field information cannot be read from the packet header of each data packet by using the fixed second preset field address.

Step 311: determining the target server parameter as the client communication object, based on the read second field information; and

Step 312: forwarding the data packet to a target server corresponding to the target server parameter.

On the basis of step 310, in step 311, the executing body may determine the target server parameter as the client communication object based on the read second field information, and then forward the data packet to the target server corresponding to the target server parameter through step 312, to finally accomplish the data forwarding.

On the basis of any of the above embodiments, the present embodiment uses the first preset field and the second preset field in sequence to finally and accurately determine various cases in order to finally accomplish accurate forwarding of the data packet. The first preset field is used to store the scheduling algorithm adoption identifier, and whether connection migration is supported and/or whether the data packet is the first data packet are determined based on whether there is valid content stored, whether the stored valid content is the scheduling algorithm adoption identifier. Only when it is determined that the first field information records the scheduling algorithm adoption identifier, the second field information can be read from the second preset field to accomplish accurate forwarding of non-first data packets.

On the basis of any of the above embodiments, the memory space for storing the session parameter is precious regardless of whether it is the exclusive memory space or the shared memory space. Therefore, based on an unused duration of a session corresponding to the recorded session parameter, a session parameter exceeding a preset keep-alive duration may be determined as a target session parameter, and the target session parameter may be deleted to ensure that there is enough space to accommodate new session parameters generated subsequently.

Further, considering that many factors may cause network environment switching in actual situations, if a unified keep-alive duration were set for all situations and/or all recorded session parameters, an actual effect may not be good, making users feel less “humanized”, less “intelligent”.

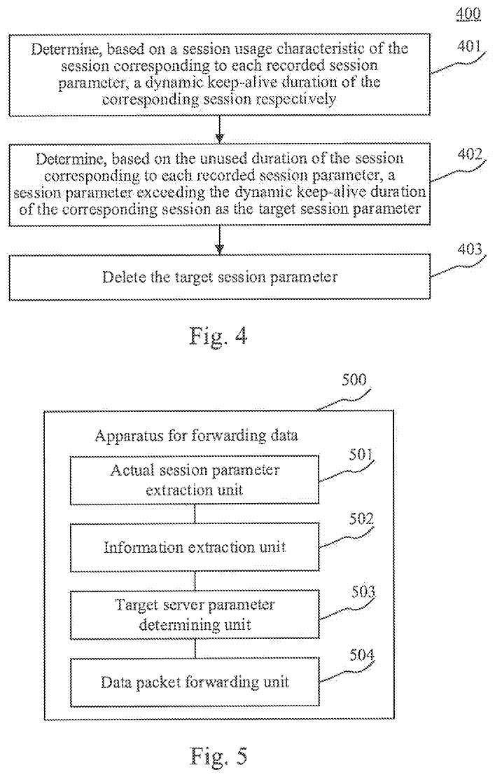

In order to improve the rationality and intelligence of the keep-alive duration as much as possible, an embodiment of the present disclosure also provides a method for processing a timeout session parameter based on a dynamic keep-alive duration. Referring to a flowchart as shown in FIG. 4, where a flow 400 includes the following steps:

Step 401: determining, based on a session usage characteristic of the session corresponding to each recorded session parameter, a dynamic keep-alive duration of the session corresponding to each recorded session parameter respectively;

The session usage characteristic includes at least one of: a duration of last use, a time length since last disconnection time point to a current time point, the number of disconnections or connections within a preset time period, an average use duration within a preset time period, an average disconnection duration within a preset time period, a period distribution of staying connected or disconnected, or location information.

Step 402: determining, based on the unused duration of the session corresponding to each recorded session parameter, a session parameter exceeding the dynamic keep-alive duration of the corresponding session as the target session parameter; and

Step 403: deleting the target session parameter.

On the basis of the basic solution of configuring a unified keep-alive duration for all sessions, the present embodiment provides a solution for determining a dynamic keep-alive duration for each session based on analysis of the session usage characteristic, so as to flexibly and dynamically set a dynamically changing keep-alive duration for each session corresponding to a different situation, based on the session usage characteristic to describe various aspects of the session, so as to provide differentiated keep-alive judgments for different sessions, thus making deletion and recreation of session parameters more reasonable and reducing performance overhead.

The last duration/average use duration can reflect, from time windows of different lengths, the user's continuity of use in a certain network environment; the time length since last disconnection time point to the current time point, and the average disconnection duration can reflect, from different time lengths, whether the user has completely detached from the current network environment; the number of disconnections or connections within a preset time period is used to reflect the number of switches between different network environments, usually corresponding to frequent switches in different areas; the time period distribution of staying connected or disconnected is used to represent whether the user's behavior of switching the network environment is related to or periodic with time periods, and then adjust the keep-alive duration in different time periods based on periodicity; and the location information is used to determine contingency or repetition of the user being in the area based on a location difference.

In order to deepen the understanding of the entire technical solution, the present embodiment also proposes an implementation in combination with RFC9000 (the official standardized version of the QUIC transmission communication protocol):

In order for the load balancing device to accurately identify the server to which the data packet sent by the client should be directed, for a DCID field of the packet header of the data packet in the QUIC, the present embodiment proposes a new DCID (Destination Connection ID) filed format, to accurately identify the target server as a forwarding target with the help of the DCID field following the new format.

1. The present embodiment defines the format of the DCID field as:

Server nonce (64-bit), Magic code&version (32-bit), Server cookie (32-bit), Random nonce (32). That is, the DCID field with a total length of 20 bytes (160 bits) is defined as a combination of 4 subfields, and a meaning of each field is:

1) The Server nonce field represents a random number generated by a backend server or related algorithm implementation, such as a socket ID that can use UDP;

2) The magic code&version field (equivalent to the first preset field described in the flow 300) is used to denote whether the scheduling algorithm provided in embodiments of the present disclosure is adopted;

3) The server cookie field (equivalent to the second preset field described in the flow 300) is a core of the scheduling algorithm provided in embodiments of the present disclosure, and is used to identify relevant information of the backend server selected by the load balancing device. Taking an IP address and a service port as an example, this field may be obtained using CRC32 or other equivalent calculation algorithms: server_cookie=crc32(serverip:port);

4) The Random nonce field represents the random number generated by the backend server.

2. Scheduling Process

Step 1: A load balancing device receives a client (client end) initial message indicating creating a connection sent from the client, then finds a corresponding session in this CPU memory based on a five-tuple recorded in the message, if the session is found, the message is forwarded to the backend server recorded by the session; if no session is found, perform step 2;

Step 2: extracts a value of the magic code&version field, determines whether the value meets requirements of the referring scheduling algorithm. If the value does not meet the requirements, it is considered that the data packet carrying the message is a first client initial message for establishing a connection between the client and a server. In this regard, it needs to choose a backend server that is capable of providing services and create a new session in this CPU memory, and forward the data packet to the chosen backend server; and

Step 3: if the value of the magic code&version field meets the requirements of the referring scheduling algorithm, extracts a value of the server cookie field from the message, determines the corresponding backend server by parsing the value of the field, and re-creates session information on this CPU or the device, then forwards the message to the corresponding backend server, so that subsequent incoming messages may be directly forwarded through the recorded five-tuple information.

By applying the custom DCID field approach and the scheduling method mentioned in the present embodiment, the problem of session disconnection caused by QUIC connection migration in a load balancing cluster may be simply and reliably solved, and the following problem may also be solved:

Compared with the forwarding performance degradation caused by using the global session problem, the CPU-level session is used in this solution (that is, each CPU has the exclusive memory space to store session information), therefore, there is no need to use global locks, which avoids performance degradation caused by contention for locks.

With further reference to FIG. 5, as an implementation of the method shown in the above figures, an embodiment of the present disclosure provides an apparatus for forwarding data, which corresponds to the method embodiment shown in FIG. 2, and the apparatus may be applied to various electronic devices.

As shown in FIG. 5, an apparatus 500 for forwarding data of the present embodiment may include: an actual session parameter extraction unit 501, an information extraction unit 502, a target server parameter determining unit 503 and a data packet forwarding unit 504. The actual session parameter extraction unit 501 is configured to obtain a data packet sent by a client, and extract an actual session parameter from the data packet. The information extraction unit 502 is configured to read information from a preset field address constituting a packet header of the data packet, in response to the actual session parameter being an unrecorded session parameter; where a preset field corresponding to the preset field address is configured to record information used to determine a target server parameter. The target server parameter determining unit 503 is configured to determine, based on target information read from the preset filed address, the target server parameter as the client communication object, in response to determining that the information read from the preset field address is not empty. The data packet forwarding unit 504 is configured to forward the data packet to a target server corresponding to the target server parameter.

In the present embodiment, in the apparatus 500 for forwarding data: for the detailed processing and the technical effects of the actual session parameter extraction unit 501, the information extraction unit 502, the target server parameter determining unit 503 and the data packet forwarding unit 504, reference may be made to the relevant descriptions of steps 201-204 in the corresponding embodiment of FIG. 2 respectively, and detailed description thereof will be omitted.

In some alternative implementations of the present embodiment, the apparatus 500 for forwarding data may further include:

a session parameter querying unit, configured to query the actual session parameter in a memory space corresponding to a current central processing unit;

an unrecorded session parameter determining unit, configured to determine, in response to determining that a session parameter same as the actual session parameter is not stored in the memory space, the actual session parameter as the unrecorded session parameter; or

a recorded session parameter determining and processing unit, configured to determine, in response to the determining that a session parameter same as the actual session parameter is stored in the memory space, the actual session parameter as a recorded session parameter, and forward the data packet to a target server corresponding to the recorded session parameter.

In some alternative implementations of the present embodiment, the memory space includes an exclusive memory space corresponding only to the current central processing unit, and a shared memory space corresponding to multiple central processing units including the current central processing unit at the same time.

In some alternative implementations of the present embodiment, the information extraction unit 502 may include:

a first field information reading subunit, configured to read first field information from a first preset field address constituting the packet header of the data packet;

a second preset field address determining subunit, configured to, in response to determining that the first field information read from the first preset field address is not empty and the first field information is a preset scheduling algorithm adoption identifier, determine a second preset field address based on the first preset field address; where, the scheduling algorithm adoption identifier is used to denote that the data packet adopts a preset scheduling algorithm;

a second field information reading subunit, configured to read second field information from the second preset field address; and

the target server parameter determining unit 503 may be further configured to:

determine the target server parameter as the client communication object, based on the second field information read from the second preset field address.

In some alternative implementations of the present embodiment, the information extraction unit 502 may further include:

a first data packet determining subunit, configured to determine, in response to determining that the first field information read from the first preset field address is not the scheduling algorithm adoption identifier, the data packet as a first data packet that initiates a communication with a server; and

a new session parameter creation subunit, configured to record the actual session parameter as a new session parameter.

In some alternative implementations of the present embodiment, the target information includes a result of performing cyclic redundancy check on an IP address of the target server and a communication port of the target server.

In some alternative implementations of the present embodiment, the apparatus 500 for forwarding data may further include:

a target session parameter determining unit, configured to determine, based on an unused duration of a session corresponding to each recorded session parameter, a session parameter exceeding a preset keep-alive duration as a target session parameter; and

a session parameter deletion unit, configured to delete the target session parameter.

In some alternative implementations of the present embodiment, the apparatus 500 for forwarding data may further include:

a dynamic keep-alive duration determining unit, configured to determine, based on a session usage characteristic of a session corresponding to each recorded session parameter, a dynamic keep-alive duration of a session corresponding to each recorded session parameter respectively; where, the session usage characteristic includes at least one of: a duration of last use, a time length since last disconnection time point to a current time point, the number of disconnections or connections within a preset time period, an average use duration within a preset time period, an average disconnection duration within a preset time period, a period distribution condition of staying connected or disconnected, or location information; and

the target session parameter determining unit may be further configured to:

determine, based on the unused duration of the session corresponding to each recorded session parameter, a session parameter exceeding the dynamic keep-alive duration of the corresponding session as the target session parameter.

The present embodiment serves as an apparatus embodiment corresponding to the above method embodiment.

Based on a connection migration idea provided by the QUIC protocol, in the apparatus for forwarding data provided by this embodiment of the present disclosure, when each load balancing device determines that itself does not record the actual session parameter of the data packet, field information may be extracted from the preset field address constituting the packet header of the data packet, so as to determine whether the connection migration is supported based on whether valid content can be extracted, and the target server parameter may be determined based on the extracted pre-written valid content in the case of that connection migration is supported. Furthermore, in the case of introducing a load balancing mechanism, it can also be ensured that the data packet is accurately forwarded to the original target server. Moreover, since there is no need to additionally set up an intermediate device that records global session information and provides global search for each load balancing device, it not only reduces an implementation cost, but also improves a forwarding efficiency.

According to an embodiment of the present disclosure, an electronic device is provided. The electronic device includes: at least one processor; and a memory communicatively connected to the at least one processor; where, the memory stores instructions that, when executed by the at least one processor, cause the at least one processor to perform the method for forwarding data described in any of the foregoing embodiments.

According to an embodiment of the present disclosure, a readable storage medium is provided, the a readable storage medium stores computer instructions that, when executed by a computer, cause the computer to perform the method for forwarding data described in any of the foregoing embodiments.

According to an embodiment of the present disclosure, a computer program product is provided, the computer program product comprises a computer program that, when executed by a processor, cause the processor to implement the method for forwarding data described in any of the foregoing embodiments.

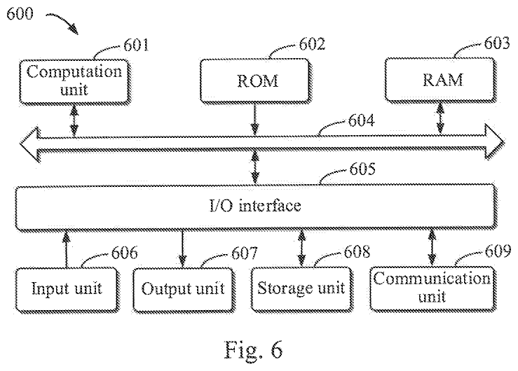

FIG. 6 illustrates a schematic block diagram of an example electronic device 600 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The parts shown herein, their connections and relationships, and their functions are merely examples, and are not intended to limit the implementation of the present disclosure described and/or claimed herein.

As shown in FIG. 6, the device 600 includes a computation unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computation unit 601, the ROM 602, and the RAM 603 are connected to each other through a bus 604. An input/output (I/O) interface 605 is also connected to the bus 604.

A plurality of parts in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 609, for example, a network card, a modem, or a wireless communication transceiver. The communication unit 609 allows the device 600 to exchange information/data with other devices over a computer network such as the Internet and/or various telecommunication networks.

The computation unit 601 may be various general-purpose and/or dedicated processing components having processing and computing capabilities. Some examples of the computation unit 601 include, but are not limited to, central processing unit (CPU), graphics processing unit (CPU), various dedicated artificial intelligence (AI) computing chips, various computation units running machine learning model algorithms, digital signal processors (DSP), and any appropriate processors, controllers, microcontrollers, etc. The computation unit 601 performs the various methods and processes described above, such as a method for forwarding data. For example, in some embodiments, the method for forwarding data may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computation unit 601, one or more steps of the method for forwarding data described above may be performed. Alternatively, in other embodiments, the computation unit 601 may be configured to perform the method for forwarding data by any other appropriate means (for example, by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, also known as a cloud computing server or a cloud host. It is a host product in the cloud computing service system to solve the defects of the traditional physical host and virtual private server (VPS) services, such as high management difficulty and weak business scalability.

Based on the connection migration idea provided by the QUIC protocol, in embodiments of the present disclosure, when each load balancing device determines that it does not record the actual session parameter of the data packet, field information may be extracted from the preset field address constituting the packet header of the data packet, so as to determine whether connection migration is supported based on whether valid content can be extracted, and the target server parameter may be determined based on the extracted pre-written valid content in the case of that connection migration is supported. Furthermore, in the case of introducing a load balancing mechanism, it can also be ensured that the data packet is accurately forwarded to the original target server. Moreover, since there is no need to additionally set up an intermediate device that records global session information and provides global search for each load balancing device, it not only reduces an implementation cost, but also improves a forwarding efficiency.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for forwarding data, the method comprising:
obtaining a data packet sent by a client, and extracting an actual session parameter from the data packet;
in response to the actual session parameter being an unrecorded session parameter, reading information from a preset field address constituting a packet header of the data packet; wherein a preset field corresponding to the preset field address is configured to record information used to determine a target server parameter;
in response to determining that the information read from the preset field address is not empty, determining, based on target information read from the preset field address, the target server parameter as a client communication object; and
forwarding the data packet to a target server corresponding to the target server parameter.

2. The method according to claim 1, wherein the method further comprises:
querying the actual session parameter in a memory space corresponding to a current central processing unit;
in response to determining that a session parameter same as the actual session parameter is not stored in the memory space, determining the actual session parameter as the unrecorded session parameter; or
in response to determining that a session parameter same as the actual session parameter is stored in the memory space, determining the actual session parameter as a recorded session parameter, and forwarding the data packet to a target server corresponding to the recorded session parameter.

3. The method according to claim 2, wherein, the memory space comprises an exclusive memory space corresponding only to the current central processing unit, and a shared memory space corresponding to multiple central processing units including the current central processing unit at the same time.

4. The method according to claim 1, wherein, the reading information from a preset field address constituting a packet header of the data packet, comprises:
reading first field information from a first preset field address constituting the packet header of the data packet;
in response to determining that the first field information read from the first preset field address is not empty and the first field information is a preset scheduling algorithm adoration identifier, determining a second preset field address based on the first preset field address; wherein, the scheduling algorithm adoption identifier is used to denote that the data packet adopts a preset scheduling algorithm;
reading second field information from the second preset field address; and
the determining, based on the target information read from the preset field address, the target server parameter as the client communication object, comprises:
determining, based on the second field information read from the second preset field address, the target server parameter as the client communication object.

5. The method according to claim 4, wherein the method further comprises:
in response to determining that the first field information read from the first preset field address is not the scheduling algorithm adoption identifier, determining the data packet as a first data packet that initiates a communication with a server; and
recording the actual session parameter as a new session parameter.

6. The method according to claim 1, wherein the target information comprises a result of performing cyclic redundancy check on an IP address of the target server and a communication port of the target server.

7. The method according to claim 1, wherein the method further comprises:
determining, based on an unused duration of a session corresponding to each recorded session parameter, a session parameter exceeding a preset keep-alive duration as a target session parameter; and
deleting the target session parameter.

8. The method according to claim 7, wherein the method further comprises:
determining, based on a session usage characteristic of a session corresponding to each recorded session parameter, a dynamic keep-alive duration of a session corresponding to each recorded session parameter respectively; wherein, the session usage characteristic comprises at least one of: a duration of last use, a time length since last disconnection time point to a current time point, a number of disconnections or connections within a preset time period, an average use duration within the preset time period, an average disconnection duration within the preset time period, a time period distribution of staying connected or disconnected, or location information; and
the determining, based on an unused duration of a session corresponding to each recorded session parameter, a session parameter exceeding a preset keep-alive duration as a target session parameter, comprises:
determining, based on the unused duration of the session corresponding to each recorded session parameter, a session parameter exceeding the dynamic keep-alive duration of the corresponding session as the target session parameter.

9. A load balancing device, comprising:
at least one processor; and
a memory communicatively connected to the at least one processor; wherein,
the memory stores instructions that, when executed by the at least one processor, cause the at least one processor to perform operations, the operations comprising:
obtaining a data packet sent by a client, and extracting an actual session parameter from the data packet;
in response to the actual session parameter being an unrecorded session parameter, reading information from a preset field address constituting a packet header of the data packet; wherein a preset field corresponding to the preset field address is configured to record information used to determine a target server parameter;
in response to determining that the information read from the preset field address is not empty, determining, based on target information read from the preset field address, the target server parameter as a client communication object; and
forwarding the data packet to a target server corresponding to the target server parameter.

10. The load balancing device according to claim 9, wherein the operations further comprise:
querying the actual session parameter in a memory space corresponding to a current central processing unit;
in response to determining that a session parameter same as the actual session parameter is not stored in the memory space, determining the actual session parameter as the unrecorded session parameter; or
in response to determining that a session parameter same as the actual session parameter is stored in the memory space, determining the actual session parameter as a recorded session parameter, and forwarding the data packet to a target server corresponding to the recorded session parameter.

11. The load balancing device according to claim 10, wherein, the memory space comprises an exclusive memory space corresponding only to the current central processing unit, and a shared memory space corresponding to multiple central processing units including the current central processing unit at the same time.

12. The load balancing device according to claim 9, wherein, the reading information from a preset field address constituting a packet header of the data packet, comprises:
reading first field information from a first preset field address constituting the packet header of the data packet;
in response to determining that the first field information read from the first preset field address is not empty and the first field information is a preset scheduling algorithm adoption identifier, determining a second preset field address based on the first preset field address; wherein, the scheduling algorithm adoption identifier is used to denote that the data packet adopts a preset scheduling algorithm;
reading second field information from the second preset field address; and
the determining, based on the target information read from the preset field address, the target server parameter as the client communication object, comprises:
determining, based on the second field information read from the second preset field address, the target server parameter as the client communication object.

13. The load balancing device according to claim 12, wherein the operations further comprise:
in response to determining that the first field information read from the first preset field address is not the scheduling algorithm adoption identifier, determining the data packet as a first data packet that initiates a communication with a server; and
recording the actual session parameter as a new session parameter.

14. The load balancing device according to claim 9, wherein the target information comprises a result of performing cyclic redundancy check on an IP address of the target server and a communication port of the target server.

15. The load balancing device according to claim 9, wherein the operations further comprise:
determining, based on an unused duration of a session corresponding to each recorded session parameter, a session parameter exceeding a preset keep-alive duration as a target session parameter; and
deleting the target session parameter.

16. The load balancing device according to claim 15, wherein the operations further comprise:
determining, based on a session usage characteristic of a session corresponding to each recorded session parameter, a dynamic keep-alive duration of a session corresponding to each recorded session parameter respectively; wherein, the session usage characteristic comprises at least one of: a duration of last use, a time length since last disconnection time point to a current time point, a number of disconnections or connections within a preset time period, an average use duration within the preset time period, an average disconnection duration within the preset time period, a time period distribution of staying connected or disconnected, or location information; and
the determining, based on an unused duration of a session corresponding to each recorded session parameter, a session parameter exceeding a preset keep-alive duration as a target session parameter, comprises:
determining, based on the unused duration of the session corresponding to each recorded session parameter, a session parameter exceeding the dynamic keep-alive duration of the corresponding session as the target session parameter.

17. A non-transitory computer readable storage medium storing computer instructions that, when executed by a computer, cause the computer to perform operations, the operations comprise:
obtaining a data packet sent by a client, and extracting an actual session parameter from the data packet;
in response to the actual session parameter being an unrecorded session parameter, reading information from a preset field address constituting a packet header of the data packet; wherein a preset field corresponding to the preset field address is configured to record information used to determine a target server parameter;
in response to determining that the information read from the preset field address is not empty, determining, based on target information read from the preset field address, the target server parameter as a client communication object; and
forwarding the data packet to a target server corresponding to the target server parameter.

18. The computer readable storage medium according to claim 17, wherein the operations further comprise:
querying the actual session parameter in a memory space corresponding to a current central processing unit;
in response to determining that a session parameter same as the actual session parameter is not stored in the memory space, determining the actual session parameter as the unrecorded session parameter; or
in response to determining that a session parameter same as the actual session parameter is stored in the memory space, determining the actual session parameter as a recorded session parameter, and forwarding the data packet to a target server corresponding to the recorded session parameter.

19. The computer readable storage medium according to claim 18, wherein, the memory space comprises an exclusive memory space corresponding only to the current central processing unit, and a shared memory space corresponding to multiple central processing units including the current central processing unit at the same time.

20. A data transmission system, comprising:
the load balancing device according to claim 9;
a client end, configured to send a data packet to the load balancing device; and
a server, configured to receive the data packet from the load balancing device.
